(19) United States
(12) Patent Application Publication
(10) Pub. No.: US 2026/0203932 A1
(43) Pub. Date: Jul. 16, 2026

(54) ELECTRONIC APPARATUS AND CONTROL METHOD THEREOF

(71) Applicant: SAMSUNG ELECTRONICS CO., LTD., Suwon-si (KR)

(72) Inventors: Seonghoon SONG, Suwon-si (KR); Seola JEONG, Suwon-si (KR); Changmin LEE, Suwon-si (KR); Seunggoo LEE, Suwon-si (KR); Changgun KO, Suwon-si (KR)

(73) Assignee: SAMSUNG ELECTRONICS CO., LTD., Suwon-si (KR)

(21) Appl. No.: 19/551,022

(22) Filed: Feb. 26, 2026

Related U.S. Application Data
(63) Continuation of application No. PCT/KR2026/000840, filed on Jan. 14, 2026.

(30) Foreign Application Priority Data
Jan. 14, 2025 (KR) 10-2025-0005099

(51) Int. Cl. G06T 7/70; G06F 3/0482; G06F 3/04845

(52) U.S. Cl. CPC G06T 7/70; G06F 3/0482; G06F 3/04845

(57) ABSTRACT

Disclosed is an electronic apparatus. One or more processors, when instructions are executed individually or collectively, cause the electronic apparatus to, based on a preference object being identified among a plurality of objects included in contents, input a plurality of frames associated with the contents to a trained first artificial intelligence model and identify a plurality of object positions with respect to each of the plurality of frames, based on the preference object not being included in a first frame, among the plurality of frames, which is output to a display, input a position of the preference object with respect to each of the plurality of frames and camera viewing angle information of each of the plurality of frames to a trained second artificial intelligence model and obtain position information of the preference object estimated with respect to the first frame, and based on the position information of the preference object, display a graphic user interface (GUI) to indicate the estimated position of the preference object in the first frame through a display.

### CROSS-REFERENCE TO RELATED APPLICATION

This application is a continuation application is a continuation application, under 35 U.S.C. § 111(a), of international application No. PCT/KR2026/000840, filed Jan. 14, 2026 which claims priority under 35 U.S.C. § 119 to Korean Patent Application No. 10-2025-0005099, filed Jan. 14, 2025, the disclosures of which are incorporated herein by reference in their entireties.

### BACKGROUND

### Field

This disclosure relates to an electronic apparatus and a control method thereof.

### Description of Related Art

With the advancement of AI technologies, a technology for identifying a dynamic object in contents by using AI and recognizing a position of the object, in real time, have been recently developed.

Ordinarily, the user may select any one of a plurality of objects in contents through a separate controller, and a position of the selected object may be displayed on an output screen in real time. However, in the case where the object selected by the user is not included in an output frame of the contents viewed by the user, it is difficult for the user to identify the position of the selected object without a separate controller.

### SUMMARY

According to one or more embodiments, an electronic apparatus includes a display, memory storing instructions, and one or more processors including processing circuitry.

According to one or more embodiments, the one or more processors, to execute the instructions are executed individually or collectively, to cause the electronic apparatus to, based on a plurality of frames corresponding to contents, obtain a position corresponding to a preference object among a plurality of objects included in the contents of each of the plurality of frames through a first artificial intelligence model, based on the preference object not being included in a first frame, among the plurality of frames, which is output to the display, obtain position information of the preference object through a second artificial intelligence model according to a position corresponding to the preference object with respect to each of the plurality of frames and camera viewing angle information of each of the plurality of frames, and based on the position information of the preference object obtained through the second artificial intelligence model, control the display to output a user interface (UI) including an indicator corresponding to an estimated position of the preference object in the first frame.

According to one or more embodiments, position information of the preference object is a first position information, and the instructions, executed by the one or more processors individually or collectively, cause the electronic apparatus to obtain first viewing angle information of a camera corresponding to the first frame, obtain second position information of the preference object included in a second frame prior to the first frame and second viewing angle information of a camera corresponding to the second frame, obtain third position information of the preference object included in a third frame between the first frame and the second frame and third viewing angle information of a camera corresponding to the third frame, and based on first viewing angle information of the camera, second position information of the preference object, second viewing angle information of the camera, third position information of the preference object, and third viewing angle information of the camera, obtain the first position information of the preference object corresponding to the first frame through the second artificial intelligence model.

According to one or more embodiments, the instructions, executed by the one or more processors individually or collectively, cause the electronic apparatus to, based on the preference object not being included in a first frame output to the display among the plurality of frames, input a position corresponding to the preference object with respect to each of the plurality of frames, camera viewing angle information of each of the plurality of frames and frame rate information of the plurality of frames to the (trained) second artificial intelligence model and obtain first position information of the preference object corresponding to the first frame.

According to one or more embodiments, the instructions, executed by the one or more processors individually or collectively, cause the electronic apparatus to, based on a plurality of object positions and the camera viewing angle information with respect to each of the plurality of frames, control the display to output the plurality of object positions and a visual field of a camera in a top view image corresponding to an entire space of the contents.

According to one or more embodiments, the instructions, executed by the one or more processors individually or collectively, cause the electronic apparatus to, control the display to output a top view image of each of the plurality of frames, including the plurality of object positions and a visual field of the camera, to each of the plurality of frames in a picture-in-picture (PIP) form.

According to one or more embodiments, the instructions, executed by the one or more processors individually or collectively, cause the electronic apparatus to, based on a plurality of object positions included in the first frame, control the display to output a UI associated with a position corresponding to the preference object to one of a plurality of edge areas of the first frame.

According to one or more embodiments, the electronic apparatus further incudes communication circuitry, and the instructions, when executed by the one or more processors individually or collectively, cause the electronic apparatus to, based on data corresponding to a plurality of captured images of the contents, obtained at a plurality of different capturing angles, being received through the communication circuitry, obtain a position corresponding to the preference object from the first frame according to data corresponding to the plurality of captured images.

According to one or more embodiments, the instructions, executed by the one or more processors individually or collectively, cause the electronic apparatus to, control the display to output a UI corresponding to a selection of a preference object among the plurality of objects included in the contents, and identify an object selected through a UI corresponding to a selection of the preference object as the preference object.

According to one or more embodiments, the instructions, executed by the one or more processors individually or collectively, cause the electronic apparatus to, based on information corresponding to a first object included in an entire space corresponding to the contents and information corresponding to a second object included in each of the plurality of frames, obtain camera viewing angle information of each of the plurality of frames.

According to one or more embodiments, the instructions, executed by the one or more processors individually or collectively, cause the electronic apparatus to, based on an image, corresponding to contents displaying a position of the preference object with respect to each of the plurality of frames, being received from a server through the communication circuitry, obtain first position information of the preference object corresponding to the first frame, and based on first position information of the preference object, control the display to output a user interface (UI) including an indicator corresponding to an estimated position of the preference object to the first frame.

According to one or more embodiments, a control method of an electronic apparatus includes, based on a plurality of frames corresponding to contents, obtaining a position corresponding to a preference object among a plurality of objects included in the contents of each of the plurality of frames through a first artificial intelligence model, based on the preference object not being included in a first frame among the plurality of frames, obtaining position information of the preference object through a second artificial intelligence model, according to a position corresponding to the preference object with respect to each of the plurality of frames and camera viewing angle information of each of the plurality of frames, and based on position information of the preference object obtained through a second artificial intelligence model, outputting a user interface (UI) including an indicator corresponding to an estimated position of the preference object in the first frame.

According to one or more embodiments, in a non-transitory computer-readable storage medium storing computer instructions that are executable by a processor of an electronic apparatus, to cause the electronic apparatus to perform operations, the operations including, based on a plurality of frames corresponding to contents, obtaining a position corresponding to a preference object among a plurality of objects included in the contents of each of the plurality of frames through a first artificial intelligence model, based on the preference object not being included in a first frame among the plurality of frames, obtaining position information of the preference object through a second artificial intelligence model, according to a positon corresponding to the preference object with respect to each of the plurality of frames and camera viewing angle information of each of the plurality of frames, and based on position information of the preference object obtained through a second artificial intelligence model, outputting a user interface (UI) including an indicator corresponding to an estimated position of the preference object in the first frame.

### BRIEF DESCRIPTION OF THE DRAWINGS

FIG. 1 is a view provided to explain an operation of an electronic apparatus according to one or more embodiments;

FIG. 2 is a block diagram provided to explain a configuration of an electronic apparatus according to one or more embodiments;

FIG. 3 is a block diagram provided to explain a specific configuration of an electronic apparatus according to one or more embodiments;

FIG. 4 is a view provided to explain a process in which an electronic apparatus identifies a preference object according to one or more embodiments;

FIG. 5 is a view provided to explain a process in which an electronic apparatus identifies a plurality of object positions according to one or more embodiments;

FIG. 6 is a view provided to explain a process in which an electronic apparatus obtains a top view image according to one or more embodiments;

FIGS. 7 and 8 are views provided to explain a process in which an electronic apparatus estimates a position of a preference object according to one or more embodiments;

FIG. 9 is a view provided to explain a process in which an electronic apparatus performs display in a PIP mode according to one or more embodiments;

FIGS. 10A, 10B and 11 are views provided to explain a process in which an electronic apparatus displays a GUI corresponding to a position of a preference object according to one or more embodiments;

FIG. 12 is a view provided to explain a process in which an electronic apparatus estimates a position of a preference object based on captured images captured at various angles according to one or more embodiments;

FIGS. 13 and 14 are views provided to explain a process in which an electronic apparatus performs entire operations according to one or more embodiments; and

FIG. 15 is a view provided to explain an operation method of an electronic apparatus according to one or more embodiments.

### DETAILED DESCRIPTION

General terms currently used as widely as possible are selected as the terms used in the embodiments of the disclosure considering functions in the disclosure, but may be changed based on the intention of those skilled in the art or a judicial precedent, the emergence of a new technology, or the like. In addition, in a certain case, terms arbitrarily chosen by the applicant may be included in the terms used herein. In this case, the meanings of such terms are described in detail in corresponding descriptions of the disclosure. Accordingly, the terms used in the disclosure need to be defined based on the meanings thereof and particulars throughout the disclosure rather than simply names thereof.

In the disclosure, the expression “have”, “may have”, “include”, “may include” or the like, indicates the existence of a corresponding feature (e.g., a numerical value, a function, an operation or an element such as a part and the like), and does not exclude the existence of an additional feature.

The expression of at least one from A or/and B is to be understood as indicating any one of “A” or “B” or “A and B”.

The expression “1st”, “2nd”, “first”, “second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), it is to be understood that one element may be connected to another element directly, or through yet another element (e.g., a third element).

Additionally, singular forms include plural forms as well, unless explicitly indicated otherwise. In the disclosure, the term “include” or “comprised of” and the like specifies the presence of stated features, numbers, steps, operations, elements, components or combinations thereof, but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor (not illustrated) except for a “module” or a “unit” that needs to be implemented by specific hardware.

In the disclosure, the term of user may refer to a person who uses an electronic apparatus or an apparatus which is used by the user.

Hereafter, one embodiment according to the disclosure is specifically described with reference to the accompanying drawings.

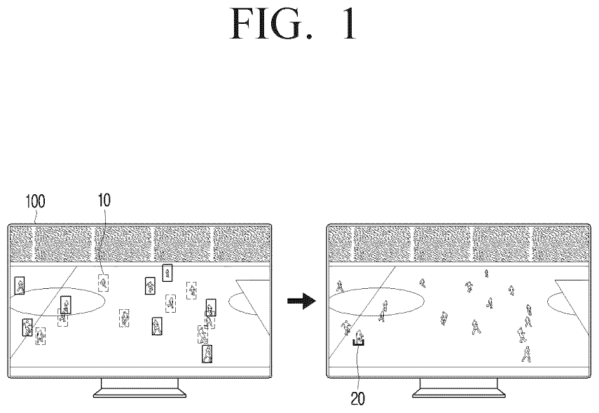

FIG. 1 is a view provided to explain an operation of an electronic apparatus according to one or more embodiments.

According to one embodiment, an electronic apparatus 100 may display an estimated position of a preference object preferred by the user through a display 110. Herein, the electronic apparatus 100 may be implemented as various types of electronic apparatuses such as a smart TV, a digital signage, a monitor, a kiosk, a tablet PC, an electronic picture frame, a mobile phone, a large format display (LFD), a digital information display (DID), a video wall, a projector display and the like. However, in some cases, the electronic apparatus 100 may be implemented as an image processing device (e.g., a set-top box, a one connect box) connecting with an electronic apparatus and providing an image.

According to one embodiment, the electronic apparatus 100 may include a display. In detail, the electronic apparatus 100 may display an obtained image or contents directly on the display.

According to one embodiment, the electronic apparatus 100 may not include a display. The electronic apparatus 100 may be connected with an external display device, and may transmit an image or contents stored in the electronic apparatus 100 to the external display device.

The electronic apparatus 100 may transmit an image or contents to the external display device together with a control signal for controlling the external display device to display the image or contents on the external display device. Herein, the external display device may be connected with the electronic apparatus 100 through communication circuitry 110 or an input/output interface 190. For example, like a set-top box (STB), the electronic apparatus 100 may not include a display.

As one example, the electronic apparatus 100 may include only a small-sized display capable of displaying simple information such as text information and the like. The electronic apparatus 100 may transmit the image or contents to the external display device in a wired or wireless manner through the communication circuitry 110 or transmit the image or contents to the external display device through the input/output interface 190.

According to one embodiment, the electronic apparatus 100 may receive, from the user, information corresponding to a preference object preferred by the user.

The preference object may include an object selected by the user based on a user input. For example, in the case where the user selects a player wearing the jersey number 3 in a soccer match, the preference object may be a human object corresponding to the player wearing the jersey number 3. However, the preference object may not be limited thereto, and may also be referred to as a selected object, a main object, a target object, a designated object, but in the disclosure, may be collectively referred to as a preference object.

According to one embodiment, the electronic apparatus 100 may identify a position of each of a plurality of objects included in contents displayed through the display 110. The electronic apparatus 100 may identify a plurality of object positions included in the contents by inputting frames corresponding to the contents to an artificial intelligence model. The electronic apparatus 100 may identify the plurality of object positions in each of the plurality of frames of the contents.

According to one embodiment, in the case where the preference object preferred by the user is not included in a first frame among the plurality of frames, the electronic apparatus 100 may identify information corresponding to an estimated position of the preference object. The electronic apparatus 100 may obtain information corresponding to a position of the preference object by inputting the plurality of frames to the artificial intelligence model, and based on the obtained information, may estimate an approximate position of the preference object.

According to one embodiment, in the case where the preference object preferred by the user is included in the first frame, the electronic apparatus 100 may display a graphic user interface (GUI) for indicating the position of the preference object through the display 110. For example, the electronic apparatus 100 may display a highlight mark for indicating the position of the preference object at the lower end of the preference object through the display 110.

Referring to FIG. 1, the electronic apparatus 100 may receive information corresponding to a preference object preferred by the user based on a user input. The electronic apparatus 100 may input a plurality of frames of contents to an artificial intelligence model to identify a position of an object 100 in each of the plurality of frames. When identifying a preference object 20 in a first frame among the plurality of frames, the electronic apparatus 100 may display a GUI for indicating a position of the preference object through the display 110.

Hereafter, various embodiments of the electronic apparatus 100 estimating a position of a preference object, and displaying a GUI for indicating the estimated position of the preference object through the display 110 when not identifying the preference object in the first frame are described with reference to the drawings.

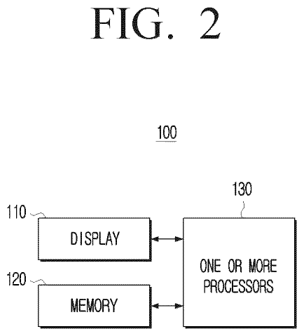

FIG. 2 is a block diagram provided to explain a configuration of an electronic apparatus according to one or more embodiments.

Referring to FIG. 2, the electronic apparatus 100 includes a display 110, memory 120 and one or more processors 130. However, the electronic apparatus 100 is not limited thereto, and may be implemented without part of the elements, or may be implemented with additional elements.

The display 110 is an element for displaying contents including a plurality of frames, and an estimated position of a preference object. The display 110 may be implemented as a display including a self light emitting element, or a display including a non-self light emitting element and backlight. For example, the display 110 may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode and the like. In the display 110, driving circuitry implementable in the form of an a-si TFT, a low temperature poly silicon (LTPS) TFT, an organic TFT (OTFT) and the like, and a backlight unit may be included together.

The memory 120 may store at least one instruction, datum, program and the like required for an operation of the electronic apparatus 100. As one example, the memory 120 may store outline highlight processing information and position information corresponding to a selected image.

The memory 120 may be implemented in the form of memory embedded in the electronic apparatus 100, or in the form of memory detachable from the electronic apparatus 100 depending on a data storage purpose. As one example, in the case of data for driving the electronic apparatus 100, the data may be stored in the memory embedded in the electronic apparatus 100, and in the case of data for an expansion function of the electronic apparatus 100, the data may be stored in memory detachable from the electronic apparatus 100.

The memory embedded in the electronic apparatus 100 may be implemented in the form of at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)).

The memory 120 may be implemented in the form of single memory storing data generated in various operations according to the disclosure, but not limited thereto. The memory 120 may also be implemented to include a plurality of memories storing different types of data respectively, or storing data generated in different steps respectively.

The one or more processors 130 control operations of the electronic apparatus 100 entirely. Specifically, the one or more processors 130 may be connected with each of the elements of the electronic apparatus 100 and control the operations of the electronic apparatus 100 entirely. For example, the one or more processors 130 may be electrically connected with the display 110 and the memory 120 to control the entire operations of the electronic apparatus 100. The one or more processors 130 may include processing circuitry, and may be comprised of one processor or multiple processors.

The one or more processors 130 may perform the operations of the electronic apparatus 100 according to various embodiments, by executing one or more instructions stored in the memory 120.

The one or more processors 130 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU) a hardware accelerator, or a machine learning accelerator. The one or more processors 130 may control one among other elements of the electronic apparatus or any combination thereof, and perform an operation in association with communication or data processing. The one or more processors 130 may execute one or more programs or instructions stored in the memory. For example, the one or more processors may perform a method according to one or more embodiments, by executing one or more instructions stored in the memory.

In the case where the method according to one or more embodiments includes a plurality of operations, the plurality of operations may be performed by one processor, or by multiple processors. For example, in the case where a first operation, a second operation, and a third operation are performed based on the method according to one or more embodiments, the first operation, the second operation and the third operation may all be performed by a first processor, or the first operation and the second operation may be performed by the first processor (e.g., a generic-purpose processor), while the third operation may be performed by a second processor (e.g., an AI-exclusive processor).

The one or more processors 130 may be implemented as a single core processor including one core, or one or more multicore processors including multiple cores (e.g., homogeneous multi cores or heterogeneous multi cores). In the case where the one or more processors 130 are implemented as a multicore processor, each of the multiple cores included in the multicore processor may include processor internal memory such as cache memory, and on-chip memory, and common cache shared by the multiple cores may be included in the multicore processor. Additionally, each of the multiple cores (or part of the multiple cores) included in the multicore processor may read and perform a program instruction for implementing the method according to one or more embodiments independently, or in the way that all (or part) of the multiple cores are associated.

In the case where the method according to one or more embodiments includes a plurality of operations, the plurality of operations may be performed by one of the multiple cores included in the multicore processor, or by the multiple cores included in the multicore processor. For example, in the case where a first operation, a second operation, and a third operation are performed based on the method according to one or more embodiments, the first operation, the second operation and the third operation may all be performed by a first core included in the multicore processor, or the first operation and the second operation may be performed by the first core included in the multicore processor, while the third operation may be performed by a second core included in the multicore processor.

In the embodiments, the processor may denote a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, a DSP, an NPU, a hardware accelerator, or a machine learning accelerator and the like, but embodiments of the disclosure may not be limited thereto. Hereafter, the one or more processors 130 are referred to as a processor 130 for convenience of description.

According to one embodiment, when identifying a preference object among a plurality of objects included in contents, the processor 130 may input a plurality of frames of the contents to a trained first artificial intelligence model to identify a plurality of object positions with respect to each of the plurality of frames.

According to one embodiment, the processor 130 may obtain a position corresponding to the preference object among the plurality of objects included in the contents of each of the plurality of frames, based on the plurality of frames corresponding to the contents, through the first artificial intelligence model.

According to one embodiment, in the case where the preference object is not included in the first frame output to the display 110 among the plurality of frames, the processor 130 may obtain first position information of the preference object corresponding to the first frame, based on the position corresponding to the preference object with respect to each of the plurality of frames and camera viewing angle information of each of the plurality of frames, through a second artificial intelligence model.

The camera viewing angle information of each of the plurality of frames may be information on a spatial range in which a camera lens is capable of capturing an image. The camera viewing angle information may include information that varies depending on a position, a focal length of a camera. For example, in the case where an image of a specific space is captured, the camera may capture an image of a wider spatial range as the camera is placed at a far position in the space and the focal length is increased.

The first position information of the preference object may include specific position information of the preference object in a frame including the preference object. For example, the first position information may be approximate position information of the preference object, or may be information corresponding to a coordinate value of the preference object in one frame.

According to one embodiment, the processor 130 may display a graphic user interface (GUI) for indicating an estimated position of the preference object in the first frame through the display 110, based on the first position information of the preference object.

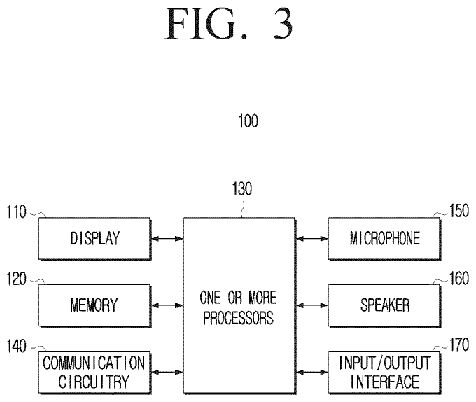

FIG. 3 is a block diagram provided to explain a specific configuration of an electronic apparatus according to one or more embodiments.

Referring to FIG. 3, the electronic apparatus 100 includes a display 110, memory 120, one or more processors 130, a communication circuitry 140, a microphone 150, a speaker 160 and an input/output interface 170. Among the elements illustrated in FIG. 3, detailed description of elements overlapping the elements illustrated in FIG. 2 is avoided.

The communication circuitry 140 may include a wired or wireless input/output interface (or input/output terminal) based on various standards. The communication circuitry 140 may be an element performing communication with various types of external devices based on various types of communication methods. The communication circuitry 140 may include a wireless communication module or a wired communication module. Herein, each communication module may be implemented in the form of at least one hardware chip.

The communication circuitry 140 may include various types of interfaces such as High Definition Multimedia Interface (HDMI), Mobile High-Definition Link (MHL), Universal Serial Bus (USB), Display Port (DP), Thunderbolt, a Video Graphics Array (VGA) port, a RGB port, D-subminiature (D-SUB), Digital Visual Interface (DVI), Bluetooth, Zigbee, wired/wireless Local Area Network (LAN), Wide Area Network (WAN), Ethernet, IEEE 1394, Audio Engineering Society/European Broadcasting Union (AES/EBU), Optical, Coaxial and the like.

The microphone 150 is an element for receiving an input of a user voice or other sounds and converting the same to audio data. The processor 130 may identify a preference object based on a user voice signal received through the microphone 150.

The speaker 160 may convert a digital audio signal processed in the processor 130 to an analogue audio signal, amplify the analogue audio signal and output the amplified analogue audio signal. For example, the speaker 160 may include at least one speaker unit, D/A converter, audio amplifier and the like capable of outputting at least one channel. For example, the speaker 160 may output information corresponding to a caller of a received call and the purpose of the call.

The input/output interface 170 may be an interface of any one of High-Definition Multimedia Interface (HDMI), Mobile High-Definition Link (MHL), Universal Serial Bus (USB), Display Port (DP), Thunderbolt, a Video Graphics Array (VGA) port, a RGB port, D-subminiature (D-SUB), and Digital Visual Interface (DVI).

The input/output interface 170 may input and output at least one of an audio signal and a video signal. Depending on embodiments, the input/output interface 170 may include a port inputting and outputting an audio signal only and a port inputting and outputting a video signal only as a separate port, or may be implemented as one port inputting and outputting both the audio signal and the video signal.

The electronic apparatus 100 may transmit at least one of the audio and video signals to an external device (e.g., an external display device or an external speaker) through the input/output interface 170. Specifically, an output port included in the input/output interface 170 may be connected with the external device, and the electronic apparatus 100 may transmit at least one of the audio and video signals to the external device through the output port.

The input/output interface 170 may be connected with the communication circuitry 140. The input/output interface 170 may transmit information received from an external device to the communication circuitry or transmit information received through a communication interface (the communication circuitry) to the external device.

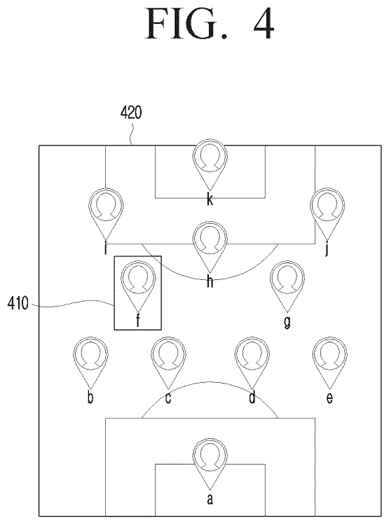

FIG. 4 is a view provided to explain a process in which an electronic apparatus identifies a preference object according to one or more embodiments.

According to one embodiment, the electronic apparatus 100 may display a guide UI for selecting a preference object among a plurality of objects included in contents through the display. The guide UI may be a UI in which a plurality of human objects included in the contents is displayed in the form of a list. For example, the guide UI may include a UI in which at least one of a human object, a name and a jersey number is displayed at a point of each position.

According to one embodiment, the electronic apparatus 100 may identify, as a preference object, an object selected through the guide UI. The electronic apparatus 100 may receive a user input for selecting any one among the plurality of human objects through the communication circuitry 140. As one example, the user may select any one among the plurality of human objects through a remote controller, or may select any one among the plurality of human objects by touching the display 110.

According to one embodiment, when identifying a preference object selected by the user among the plurality of human objects, the electronic apparatus 100 may store information corresponding to the preference object in the memory 120. The information corresponding to the preference object may include at least one of the face image, jersey number, and name of the preference object.

Referring to FIG. 4, as a soccer match starts, the electronic apparatus 100 may receive information corresponding to the soccer match from a server. For example, the electronic apparatus 100 may receive, from the server, information on a team playing the soccer match, information on players in the team, information on a strategy for the soccer match, information on a player at each position.

The electronic apparatus 100 may display, through the display 110, a guide UI 420 for selecting a preference object among the plurality of human objects based on the information received from the server. In the case where any one object among the plurality of objects is selected based on a user input, the electronic apparatus 100 may identify the selected object as a preference object 410.

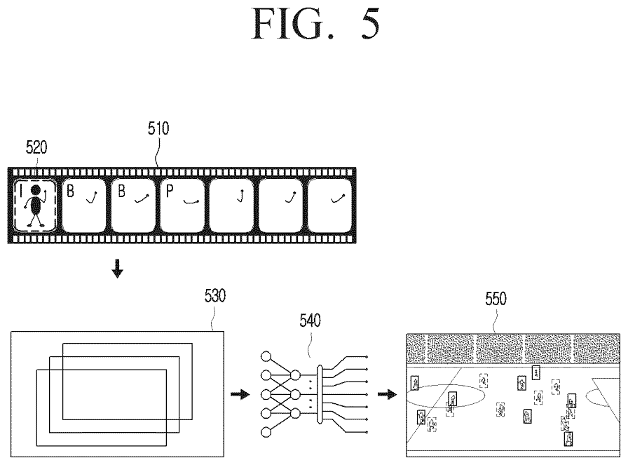

FIG. 5 is a view provided to explain a process in which an electronic apparatus identifies a plurality of object positions according to one or more embodiments.

According to one embodiment, the electronic apparatus 100 may identify a plurality of object positions of each frame by inputting, to an artificial intelligence model, a representative frame among a plurality of frames of contents.

As one example, the electronic apparatus 100 may identify an intra frame (I-Frame) that is a representative frame, based on header information of each of the plurality of frames. The intra frame, as a frame that includes complete image information in a frame itself, may be an independently compressed frame.

Referring to FIG. 5, the electronic apparatus 100 may identify a plurality of frames 510 including motion information of an object. At this time, while the object is moving, the electronic apparatus 100 may identify an intra frame 520 to represent the object. For example, in the case where the object is moving an arm only, the electronic apparatus 100 may identify, as an intra frame 510, a frame at a point in time when the arm starts to move.

As one example, the electronic apparatus 100 may identify an intra frame 520 that is a representative frame with respect to each different frame section, according to the header information or the motion information of the plurality of frames.

According to one embodiment, the electronic apparatus 100 may identify the plurality of object positions with respect to each of the plurality of frames by inputting a plurality of intra frames 530 to a first artificial intelligence model 540. The first artificial intelligence model 540 may be a model trained to identify an object, based on at least one of the image, motion information and size of each of a plurality of objects included in a frame. That is, the artificial intelligence model may be a model trained to identify object information and a position of each dynamic object in each frame.

Herein, training an artificial intelligence model may denote training a basic artificial intelligence model (e.g., an artificial intelligence model including any random parameters) by using a large number of training data through a learning algorithm, to generate predefined operational regulations or artificial intelligence models that are set to achieve desired features (or purposes). Such training may be performed through a separate server and/or system, but not limited thereto, and may also be performed by a cooking apparatus. Examples of the learning algorithm may include supervised learning, unsupervised learning, semi-supervised learning or reinforcement learning, but not limited thereto.

Herein, the artificial intelligence model, for example, may be implemented as a convolutional neural network (CNN), a recurrent neural network (RNN), a restricted Boltzmann machine (RBM), a deep belief network (DBN), a bidirectional recurrent deep neural network (BRDNN) or a Deep Q-Network and the like, but not limited thereto.

Referring to FIG. 5, the electronic apparatus 100 may input the plurality of intra frames 530 to the first artificial intelligence model 540. The electronic apparatus 100 may identify a position of each of the plurality of objects in each frame through the first artificial intelligence model 540.

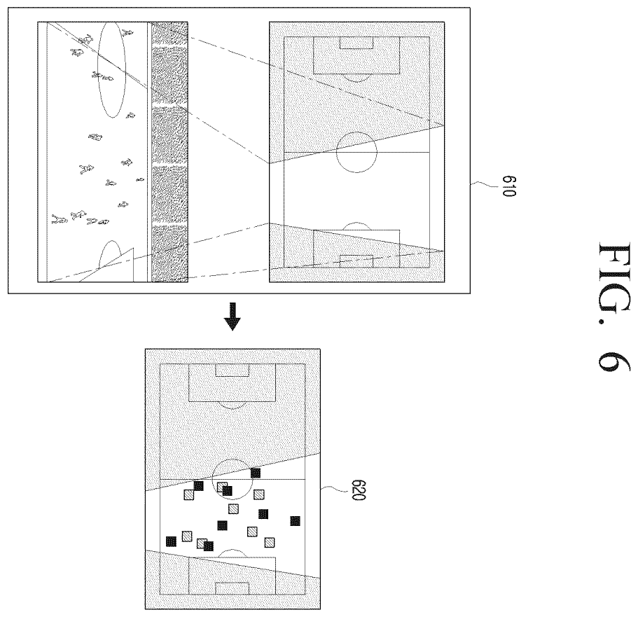

FIG. 6 is a view provided to explain a process in which an electronic apparatus obtains a top view image according to one or more embodiments.

According to one embodiment, the electronic apparatus 100 may obtain a top view image corresponding to an entire space of contents. The top view image may be an image of the entire space of the contents, captured in a perpendicular direction, i.e., an image captured from a top-down perspective. The top view image may not be limited thereto, and may also be referred to as a bird's-eye view image, and an overhead view image, but in the disclosure, the images are collectively referred to as a top view image.

According to one embodiment, based on a plurality of object positions and camera viewing angle information with respect to each of a plurality of frames, the electronic apparatus 100 may display the plurality of object positions and a visual field of a camera in the top view image through the display 110. The electronic apparatus 100 may display a top view image only displaying a range corresponding to a visual field range of a camera out of the entire space of the contents, through the display 110.

According to one embodiment, the electronic apparatus 100 may obtain information on a first object included in the entire space corresponding to the contents, and may compare the information on the first object with information on a second object included in each of the plurality of frames to obtain the camera viewing angle information of each of the plurality of frames.

The information on the first object may be information on a static object in a contents space. For example, in the case where the contents space is a soccer stadium, the first object may be a center circle, an offside line, a goal line displayed in the soccer stadium.

The information on the second object may be information on a static object (e.g., a center circle, an offside line, a goal lie) in a contents space included in a camera visual field range.

As one example, the electronic apparatus 100 may obtain viewing angle information of each frame by comparing position information on the second object and position information on the first object, included in each frame with respect to the entire space of the contents. The electronic apparatus 100 may display the camera visual field range in the top view image based on the viewing angle information of each frame.

Referring to FIG. 6, the electronic apparatus 100 may display the top view image corresponding to the entire space of the contents through the display 110. The electronic apparatus 100 may display a top view image 610 only displaying the camera visual field range based on the camera viewing angle information of each frame, through the display 110.

The electronic apparatus 100 may display a top view image 620 displaying a plurality of object positions in the top view image 610 displaying the camera visual field range, through the display 110. The electronic apparatus 100 may obtain a top view image in which a plurality of object positions is displayed, with respect to each of the plurality of frames, and may store the top view image in the memory 120.

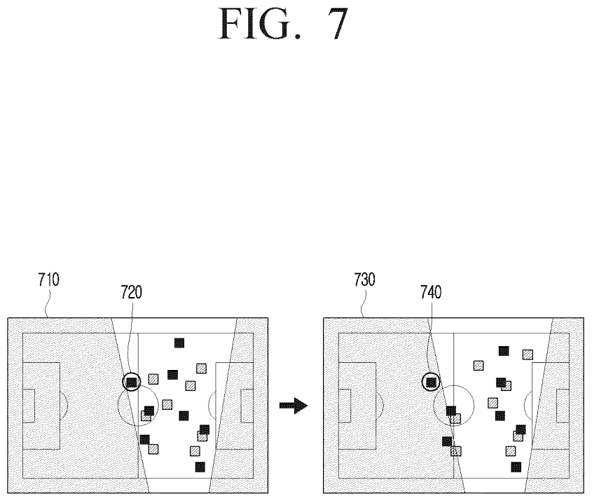

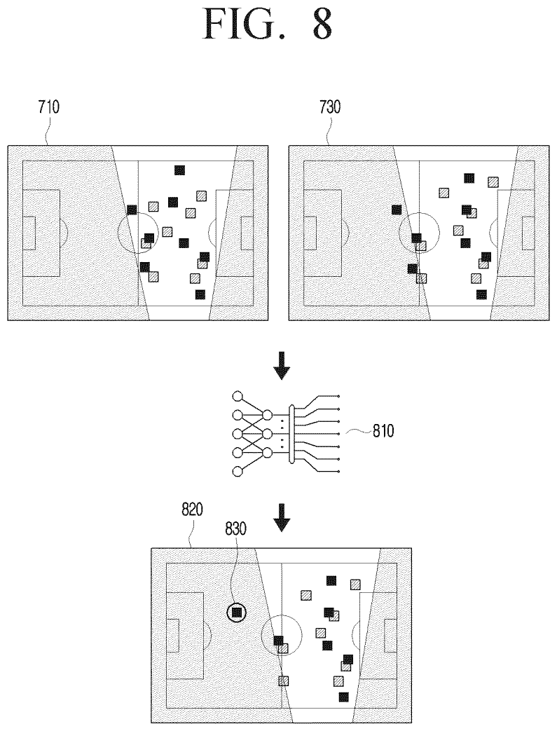

FIGS. 7 and 8 are views provided to explain a process in which an electronic apparatus estimates a position of a preference object according to one or more embodiments.

According to one embodiment, the electronic apparatus 100 may obtain first viewing angle information of a camera corresponding to a first frame. The electronic apparatus 100 may obtain a top view image corresponding to the first frame.

According to one embodiment, the electronic apparatus 100 may obtain second position information of a preference object identified from a second frame prior to the first frame, and second viewing angle information of the camera corresponding to the second frame. The electronic apparatus 100 may obtain a top view image corresponding to the second frame, and in the top view image, may display a top view image 710 displaying a second position 720 of the preference object through the display 110.

According to one embodiment, the electronic apparatus 100 may obtain third position information of the preference object identified from a third frame between the first frame and the second frame, and third viewing angle information of the camera corresponding to the third frame. The electronic apparatus 100 may obtain a top view image corresponding to the third frame, and in the top view image, may display a top view image 730 displaying a third position 740 of the preference object through the display 110.

According to one embodiment, the electronic apparatus 100 may input, to a trained second artificial intelligence model, the first viewing angle information of the camera, the second position information of the preference object, the second viewing angle information of the camera, the third position information of the preference object, and the third viewing angle information of the camera, to obtain first position information of the preference object, which is estimated with respect to the first frame. The second artificial intelligence model may be a model trained to estimate a position of a preference object in a frame at a current point in time based on camera viewing angle information of each of the plurality of frames and position information of the preference object.

In FIGS. 7 and 8, description is provided under the assumption that the time order of the frames is the order of the second frame, the third frame and the first frame one.

Referring to FIG. 7, the electronic apparatus 100 may obtain the top view image 710 corresponding to the second frame, and the top view image 730 corresponding to the third frame. In the top view image 710 corresponding to the second frame, the second position 720 of the preference object may be included in the camera visual field range. However, in the case where the viewing angle information of the camera is changed, in other words, in the case where a capturing range is changed to the right side of the entire space of the contents, the third position 740 of the preference object in the top view image 730 corresponding to the third frame may not be included in the camera visual field range.

Referring to FIG. 8, the electronic apparatus 100 may input, to a second artificial intelligence model 810, the top view image 710 corresponding to the second frame, and the top view image 730 corresponding to the third frame. The electronic apparatus 100 may identify the viewing angle information of the camera in a top view image 820 corresponding to the first frame, and identify the visual field range of the camera with respect to the entire space. The electronic apparatus 100 may identify that a preference object is not included in the camera visual field range of the top view image 820 corresponding to the first frame.

The electronic apparatus 100 may estimate a position of a preference object 830 in the top view image 820 corresponding to the first frame through the second artificial intelligence model. In the case where the capturing range of the camera with respect to the entire space is changed from the left side to the right side, the preference object may be included in the camera visual field range in the second frame, but in the first frame, the preference object may not be included in the camera visual field range.

According to one embodiment, in the case where the preference object is not included in the first frame output to the display 110, among the plurality of frames, the electronic apparatus 100 may input, to the trained second artificial intelligence model 810, the position of the preference object with respect to each of the plurality of frames, the camera viewing angle information of each of the plurality of frames, and frame rate information of the plurality of frames, to obtain first position information of the preference object, estimated with respect to the first frame.

As one example, the electronic apparatus 100 may estimate a position of the preference object in the first frame, based on a frame rate of the plurality of frames. For example, in the case of a frame rate of 100 Hz, the second frame, the third frame, and the first frame may be frames output at a 1/100-second interval. At this time, in the case where the preference object is included in the camera visual field range of the second frame and is identified at a boundary outside the camera visual field range of the third frame, the electronic apparatus 100 may estimate that in the first frame, the preference object is outside the camera visual field range.

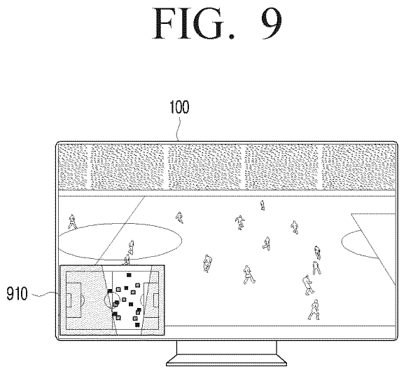

FIG. 9 is a view provided to explain a process in which an electronic apparatus performs display in a PIP mode according to one or more embodiments.

According to one embodiment, the electronic apparatus 100 may display, in a Picture-in-Picture (PIP) mode, a top view image of each of the plurality of frames, including a plurality of object positions and a visual field of the camera, in each of the plurality of frames, through the display 110.

As one example, the electronic apparatus 100 may control the display 110 to display a PIP image including a predetermined-size window, in a partial area of the display 110.

The PIP mode may be an image mode in which while contents are displayed in an entire screen, a predetermined-size image is displayed in a partial area of a display screen through a window, to provide an entire image and an image included in the predetermined-size window. The PIP mode may be an image mode in which an image having a less size than an image displayed on the entire screen is displayed in a partial area of the screen.

Referring to FIG. 9, the electronic apparatus 100 may display, in a PIP mode, a top view image 910 of each of the plurality of frames in one area of a display screen. For example, the electronic apparatus 100 may display, in a PIP mode, the top view image 910 through the predetermined-size window at the lower end of the left side of the entire image.

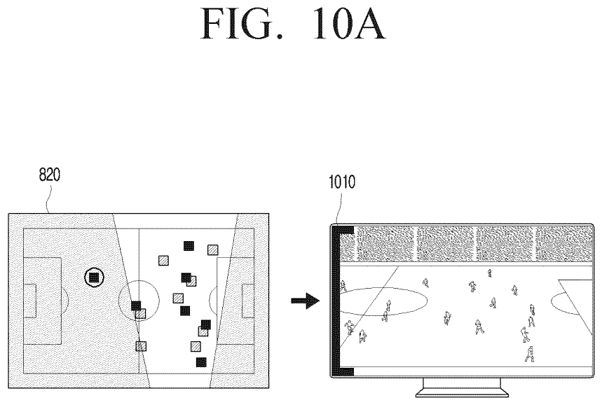

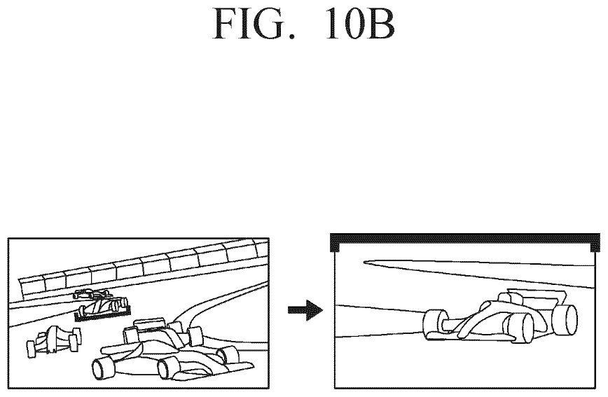

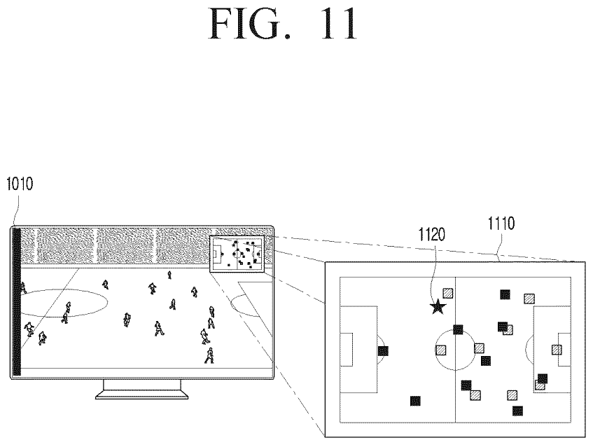

FIGS. 10A, 10B and 11 are views provided to explain a process in which an electronic apparatus displays a GUI corresponding to a position of a preference object according to one or more embodiments.

According to one embodiment, the electronic apparatus 100 may control the display 110 to output a UI associated with a position corresponding to a preference object based on a plurality of object positions included in the first frame, to one of a plurality of edge areas of the first frame.

As one example, the electronic apparatus 100 may display the GUI corresponding to the position of the preference object, estimated with respect to the plurality of object positions included in the first frame, to an edge area of the left side or the right side of the first frame, through the display 110.

As one example, the electronic apparatus 100 may control the display 110 to output a UI associated with the position corresponding to the preference object to at least one of a left-right/upper-lower area of the first frame.

For example, the electronic apparatus 100 may display a UI associated with the position corresponding to the preference object, to at least one of the left-right edge or upper-lower edge of the first frame.

Referring to FIG. 10, the electronic apparatus 100 may identify an estimated position of the preference object based on the top view image 820 corresponding to the first frame. The electronic apparatus 100 may identify whether in the first frame, the preference object is placed on the left side or the right side outside the camera visual field range. For example, in the case where in the first frame, the preference object is placed on the left side of the camera visual field range, the electronic apparatus 100 may display a GUI 1010 corresponding to the position of the preference object in the edge area of the left side of the first frame through the display 110. The GUI illustrated in FIG. 10 may not be limited thereto, and may be display in various sizes, lengths, thicknesses.

Meanwhile, in 10 A, a soccer match is descried as an example, but in 10B, a racing game is described as an example.

Referring to FIG. 10B, the electronic apparatus 100 may identify a position of a preference object among a plurality of objects included in the first frame. The electronic apparatus 100 may also identify the position of the preference object based on a top view image corresponding to the first frame. The electronic apparatus 100 may display a GUI corresponding to the position of the preference object through the display 110.

For example, when identifying a preference object preferred by the user (e.g., a racing car preferred by the user) among a plurality of objects (e.g., racing cars) included in the first frame, the electronic apparatus 100 may display a GUI corresponding to the position of the preference object through the display 110.

For example, when not identifying the preference object (e.g., a racing car preferred by the user) in the first frame, the electronic apparatus 100 may identify the position of the preference object based on the plurality of frames or images captured in different directions.

In this case, the electronic apparatus 100 may display a GUI corresponding to an estimated position of the preference object in the first frame, in the upper-lower/left-right edge areas of the display(110). For example, in the case where the position of the preference object is placed behind a racing car displayed in the first frame, a GUI corresponding to the estimated position of the preference object may be displayed at the upper end of the display in the first frame.

Meanwhile, the subject matter of the disclosure may certainly be applied to contents including a plurality of dynamic objects without being limited to a soccer match or a racing game. For example, the contents including a plurality of dynamic objects may include sports game contents such as a basketball or a baseball, bicycle racing contents. Referring to FIG. 11, the electronic apparatus 100 may display the GUI corresponding to the estimated position of the preference object and a top view image displaying the position of the preference object through the display 110. The electronic apparatus 100 may display, in a PIP mode, a top view image 1110 displaying an estimated position 1120 of the preference object through the display 110.

For example, the electronic apparatus 100 may display, as a predetermined-size window, the top view image 1110 in which the estimated position 1120 of the preference object is marked with a star in the first frame, at the upper end of the right side of the display.

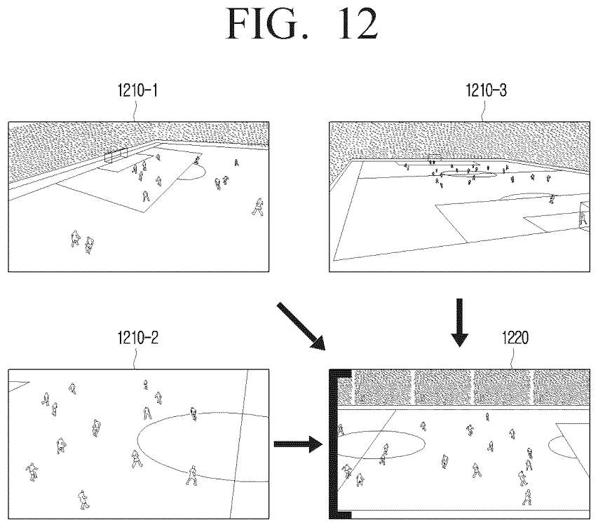

FIG. 12 is a view provided to explain a process in which an electronic apparatus estimates a position of a preference object based on captured images captured at various angles according to one or more embodiments.

According to one embodiment, when receiving a plurality of captured images of contents, captured at a plurality of different capturing angles, through the communication circuitry 140, the electronic apparatus 100 may identify a position of a preference object from the first frame based on the plurality of captured images.

As one example, when receiving a plurality of captured images of an entire space of contents, captured at different capturing angles, the electronic apparatus 100 may identify a position of a preference object in the entire space, based on the plurality of captured images.

Referring to FIG. 12, the electronic apparatus 100 may receive a plurality of captured images 1210-1 to 1210-3 of the entire space, captured at various angles, through the communication circuitry 140. The electronic apparatus 100 may identify a plurality of object positions included in each of the captured images 1210-1 to 1210-3 by inputting the plurality of captured images 1210-1 to 1210-3 to the first artificial intelligence model. The electronic apparatus 100 may identify the position of the preference object from the plurality of captured images 1210-1 to 1210-3. The electronic apparatus 100 may identify the position of the preference object in the entire space of the contents based on the plurality of captured images 1210-1 to 1210-3, and estimate the position of the preference object in the first frame. The electronic apparatus 100 may display an image 1220 displaying a GUI corresponding to the position of the preference object in the first frame through the display 110.

According to one embodiment, the electronic apparatus 100 may receive a contents image displaying the position of the preference object with respect to each of a plurality of frames from a contents streaming sever. The electronic apparatus 100 may display, through the display 110, an image displaying a GUI corresponding to an estimated position of the preference object in the first frame based on the contents image received from the server.

According to one embodiment, the electronic apparatus 100 may estimate the position of the preference object by analyzing audio data of the contents. For example, the electronic apparatus 100 may estimate the position of the preference object based on a commentary broadcast of the contents.

According to one embodiment, the electronic apparatus 100 may control a projection part 170 based on a user voice signal received through the microphone 150. For example, when receiving a user voice signal for projecting an A UI, the electronic apparatus 100 may control the projection part 170 to display the A UI.

According to one embodiment, the electronic apparatus 100 may control an external display device connected with the electronic apparatus 100, based on the user voice signal received through the microphone 150. Specifically, the electronic apparatus 100 may generate a control signal for controlling the external display device such that an operation corresponding to the user voice signal is performed by the external display device, and transmit the generated control signal to the external display device. Herein, the electronic apparatus 100 may store a remote control application for controlling the external display device. Additionally, the electronic apparatus 100 may transmit the generated control signal to the external display device by using at least one of a Bluetooth communication method, a Wi-Fi communication method or an infrared communication method. For example, when receiving a user voice signal for displaying contents A, the electronic apparatus 100 may transmit, to the external display device, a control signal for controlling the external display device such that the contents A are displayed by the external display device. Herein, the electronic apparatus 100 may denote various types of terminal devices such as a smartphone, an AI speaker and the like in which a remote control application is installable.

According to one embodiment, the electronic apparatus 100 may use a remote control device to control the external display device connected with the electronic apparatus 100 based on a user voice signal received through the microphone 150. Specifically, the electronic apparatus 100 may transmit, to the remote control device, a control signal for controlling the external display device such that an operation corresponding to the user voice signal is performed by the external display device. Additionally, the remote control device may transmit the control signal received from the electronic apparatus 100 to the external display device. For example, when receiving a user voice signal for displaying contents A, the electronic apparatus 100 may transmit, to the remote control device, a control signal for controlling the external display device such that the contents A are displayed by the external display device, and the remote control device may transmit the received control signal to the external display device.

According to one embodiment, the communication circuitry 110 may use an identical communication module (e.g., a Wi-Fi module) to communicate with an external device such as a remote control device and an external server.

According to one embodiment, the communication circuitry 110 may use a different communication module to communicate with an external device such as a remote control device and an external server. For example, the communication circuitry 110 may use at least one of an Ethernet module or a Wi-Fi module to communicate with the external server, or may use a Bluetooth module to communicate with the external device such as a remote control device. However, this is described merely as one example, and the communication circuitry 110 may use at least one of various types of communication modules, when communicating with a plurality of external devices or external servers.

According to one embodiment, the electronic apparatus 100 may receive a user voice signal through the microphone 150 included in the electronic apparatus 100.

According to one embodiment, the electronic apparatus 100 may receive a user voice signal from an external device including a microphone. Herein, the external device may denote a remote control device or a smartphone and the like. Herein, the received user voice signal may be a digital voice signal, but depending on embodiments, may be an analogue voice signal. The electronic apparatus 100 may receive the user voice signal based on a wireless communication method such as Bluetooth, or Wi-Fi and the like.

According to one embodiment, the electronic apparatus 100 may obtain text information corresponding to the user voice signal from the external server. Specifically, the electronic apparatus 100 may transmit the user voice signal (an audio signal or a digital signal) to the external server. Herein, the external server may denote a voice recognition server. Herein, the voice recognition server may convert the user voice signal to text information by using Speech-To-Text (STT). Additionally, the external server may transmit the text information corresponding to the converted user voice signal to the electronic apparatus 100.

According to one embodiment, the electronic apparatus 100 itself may obtain text information corresponding to a user voice signal. Specifically, the electronic apparatus 100 may convert a digital voice signal to text information by applying a speech to text (STT) function directly to the digital voice signal, and may transmit the converted text information to an external server.

According to one embodiment, the external server may transmit the text information corresponding to the user voice signal to the electronic apparatus 100. Specifically, the external server may be a server performing a voice recognition function of converting a user voice signal to text information.

According to one embodiment, the external server may transmit, to the electronic apparatus 100, at least one of the text information corresponding to the user voice signal or search result information corresponding to the text information. Specifically, the external server may be a server performing a search result provision function of providing search result information corresponding to text information, excluding the voice recognition function of converting a user voice signal to text information.

As one example, the external server may be a server performing both the voice recognition function and the search result provision function. As another example, the external server may perform the voice recognition function only, while a separate server may perform the search result provision function. The external server may transmit text information to the separate server to obtain a search result, and obtain the search result corresponding to the text information from the separate server.

According to one embodiment, a communication module for communicating with the external device and external server may be implemented identically. For example, the electronic apparatus 100 may communicate with the external device by using a Bluetooth module, and may also communicate with the external server by using a Bluetooth module.

According to one embodiment, a communication module for communicating with the external device and external server may be implemented separately. For example, the electronic apparatus 100 may communicate with the external device by using a Bluetooth module, while communicating with the external server by using an Ethernet modem or a Wi-Fi module.

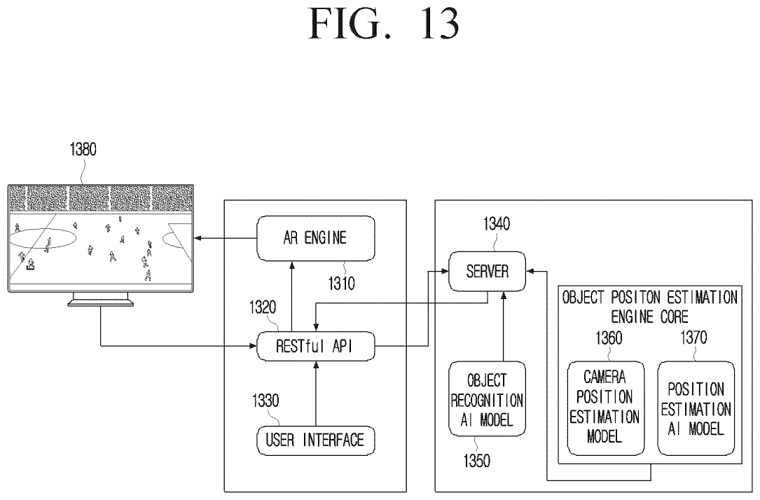

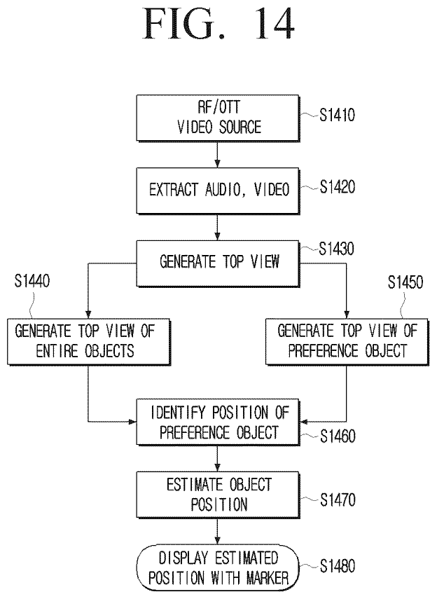

FIGS. 13 and 14 are views provided to explain a process in which an electronic apparatus performs entire operations according to one or more embodiments.

Referring to FIG. 13, the electronic apparatus 100 may receive information corresponding to a preference object among a plurality of objects through a user interface 1330. When identifying the preference object, the electronic apparatus 100 may receive a plurality of frames of contents through a RESTful API 1320. The RESTful API 1320 may be an interface for communing between the electronic apparatus 100 and a server through a network. The electronic apparatus 100 may transmit, to a server 1340, a plurality of frames of contents and information corresponding to the preference object.

As one example, the electronic apparatus 100 may identify a plurality of objects with respect to each of the plurality of frames, through an object recognition model 1350. The electronic apparatus 100 may estimate a position of the preference object with respect to each of the plurality of frames through a camera position estimation model 1360 and a preference object position estimation model 1370.

As one example, when identifying the position of the preference object in a first frame, the electronic apparatus 100 may display, through a display 110, a GUI corresponding to the estimated position of the preference object through an AR engine 1310.

Referring to FIG. 14, in operation 1410, the electronic apparatus 100 may obtain data corresponding to a video source from contents output through the display 110.

In operation 1420, the electronic apparatus 100 may identify audio data and video data from the video source.

In operation 1430, the electronic apparatus 100 may obtain a top view image corresponding respectively to the plurality of frames of the contents.

In operation 1440, the electronic apparatus 100 may obtain a top view image corresponding to an entire space of the contents.

In operation 1450, the electronic apparatus 100 may obtain a top view image in which the position of the plurality of objects and the position of the preference object are displayed in the top view image corresponding to the entire space of the contents.

In operation 1460, the electronic apparatus 100 may identify the position of the preference from the top view image of each of the plurality of frames.

In operation 1470, the electronic apparatus 100 may estimate the position of the preference object from a first image.

In operation 1480, the electronic apparatus 100 may display, through the display 110, a GUI corresponding to the estimated position of the preference object in the first frame.

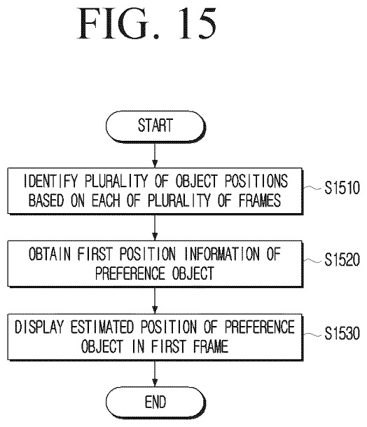

FIG. 15 is a view provided to explain an operation method of an electronic apparatus according to one or more embodiments.

Referring to FIG. 15, in operation 1510, when identifying a preference object among a plurality of objects included in contents, the electronic apparatus 100 may identify a plurality of object positions with respect to each of a plurality of frames by inputting the plurality of frames of the contents to a trained first artificial intelligence model.

In operation 1520, in the case where the preference object is not included in a first frame among the plurality of frames, the electronic apparatus 100 may obtain first position information of the preference object, estimated with respect to the first frame, by inputting a position of the preference object with respect to each of the plurality of frames and camera viewing angle information of each of the plurality of frames to a trained second artificial intelligence model.

In operation 1530, the electronic apparatus 100 may display a GUI for indicating the estimated position of the preference object in the first frame, based on the first position information of the preference object.

A method of identifying the preference object and the object position in the plurality of frames of the contents, and obtaining the first position information of the preference object is specifically described with reference to the above-described embodiments, and accordingly, description in relation to this is avoided.

The control method described with reference to FIG. 15 may be performed by the electronic apparatus 100 having the above-described configuration of FIG. 2, but not limited thereto, and may also be performed by an electronic apparatus having various configurations.

The above-described embodiments may be implemented solely, or at least one of the embodiments may be combined partially or entirely and implemented together in one device.

According to the above-described embodiments, while the user views contents, the electronic apparatus 100 may provide, to the user, an estimated position of a preference object preferred by the user, by displaying the estimated position of the preference object on a display.

Meanwhile, the above-described embodiments may be solely applied to a product, but at least part of the embodiments may be combined with another embodiment of the disclosure and implemented together.

The embodiments described above may be implemented with software including instructions stored in a storage medium readable by a machine (e.g., a computer). The machine, as a device capable of calling the stored instructions from the storage medium and operating according to the called instructions, may include the electronic apparatus (e.g., an electronic apparatus 100) according to the disclosed embodiments. Based on instructions executed by a processor, the processor may perform functions corresponding to the instructions directly, or by using other elements under the control of the processor. The instructions may include a code generated or executed by a compiler or an interpreter. The machine-readable storage medium may be provided in the form of a non-transitory computer-readable storage medium. Herein, the term “non-transitory” only means that the storage medium includes no signal and is tangible while the term does not differentiate semi-permanent or temporary storage of data in the storage medium.

According to the embodiments set forth herein, the method may be provided in a computer program product.

Specifically, the method includes inputting, based on a preference object being identified among a plurality of objects included in contents, a plurality of frames of the contents to a trained first artificial intelligence model and identifying a plurality of object positions with respect to each of the plurality of frames, inputting, based on the preference object not being included in a first frame among the plurality of frames, a position of the preference object with respect to each of the plurality of frames and camera viewing angle information of each of the plurality of frames to a trained second artificial intelligence model and obtaining first position information of the preference object estimated with respect to the first frame, and displaying, based on the first position information of the preference object, a graphic user interface (GUI) for indicating the estimated position of the preference object in the first frame.

The computer program product may be distributed in the form of a machine-readable storage medium (e.g., compact disc read only memory (CD-ROM)), or distributed online through an application store (e.g., Play Store™). In the case of online distribution, at least part of the computer program product may be stored at least temporarily, or generated temporarily in a storage medium such as a manufacturer's server, a server of an application store, or memory of a relay server.

Further, computer instructions or programs for performing the control method and the like of the electronic apparatus according to the embodiments described above may be stored in a non-transitory computer-readable medium. The computer instructions stored in the non-transitory computer-readable medium, when executed by a processor of a specific device, cause the specific device to perform the processing operations in the apparatus according to the embodiments described above. The non-transitory computer-readable medium denotes a medium that stores data semi-permanently and is readable by a machine, rather than a medium such as a register, cache, and memory and the like that store data temporarily. Specific examples of the non-transitory computer-readable medium may include a CD, a DVD, a hard disc, a blue-ray disc, a USB, a memory card, and ROM and the like.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope of the subject matter of the disclosure claimed in the section of claims, and are not to be understood as separating from the technical spirit or prospect of the disclosure.

What is claimed is:

1. An electronic apparatus comprising:
a display;
a memory to store instructions; and
one or more processors including processing circuitry, to execute the instructions individually or collectively and cause the electronic apparatus to:
based on a plurality of frames corresponding to contents, obtain a position corresponding to a preference object among a plurality of objects included in the contents of each of the plurality of frames through a first artificial intelligence model;
based on the preference object not being included in a first frame, among the plurality of frames, which is output to the display, obtain position information of the preference object through a second artificial intelligence model according to a position corresponding to the preference object with respect to each of the plurality of frames and camera viewing angle information of each of the plurality of frames; and
based on the position information of the preference object obtained through the second artificial intelligence model, control the display to output a user interface (UI) including an indicator corresponding to an estimated position of the preference object in the first frame.

2. The electronic apparatus as claimed in claim 1, wherein the position information of the preference object is a first position information, and the instructions, executed by the one or more processors individually or collectively, cause the electronic apparatus to:
obtain first viewing angle information of a camera corresponding to the first frame;
obtain second position information of the preference object included in a second frame prior to the first frame, and second viewing angle information of a camera corresponding to the second frame;
obtain third position information of the preference object included in a third frame between the first frame and the second frame, and third viewing angle information of a camera corresponding to the third frame; and
based on first viewing angle information of the camera, second position information of the preference object, second viewing angle information of the camera, third position information of the preference object, and third viewing angle information of the camera, obtain the first position information of the preference object corresponding to the first frame through the second artificial intelligence model.

3. The electronic apparatus as claimed in claim 1, wherein the instructions, executed by the one or more processors individually or collectively, cause the electronic apparatus to:
based on the preference object not being included in the first frame which is output to the display among the plurality of frames, input a position corresponding to the preference object with respect to each of the plurality of frames, camera viewing angle information of each of the plurality of frames and frame rate information of the plurality of frames to the second artificial intelligence model and obtain first position information of the preference object corresponding to the first frame.

4. The electronic apparatus as claimed in claim 1, wherein the instructions, executed by the one or more processors individually or collectively, cause the electronic apparatus to:
based on a plurality of object positions and the camera viewing angle information with respect to each of the plurality of frames, control the display to output the plurality of object positions and a visual field of a camera in a top view image corresponding to an entire space of the contents.

5. The electronic apparatus as claimed in claim 4, wherein the instructions, executed by the one or more processors individually or collectively, cause the electronic apparatus to:
control the display to output a top view image of each of the plurality of frames, including the plurality of object positions and a visual field of the camera, to each of the plurality of frames in a picture-in-picture (PIP) form.

6. The electronic apparatus as claimed in claim 1, wherein the instructions, executed by the one or more processors individually or collectively, cause the electronic apparatus to:
based on a plurality of object positions included in the first frame, control the display to output a UI associated with a position corresponding to the preference object to one of a plurality of edge areas of the first frame.

7. The electronic apparatus as claimed in claim 1, the electronic apparatus further comprising:
communication circuitry,
wherein the instructions, executed by the one or more processors individually or collectively, cause the electronic apparatus to:
based on data corresponding to a plurality of captured images of the contents, obtained at a plurality of different capturing angles, being received through the communication circuitry, obtain a position corresponding to the preference object from the first frame according to data corresponding to the plurality of captured images.

8. The electronic apparatus as claimed in claim 1, wherein the instructions, executed by the one or more processors individually or collectively, cause the electronic apparatus to:
control the display to output a UI corresponding to a selection of a preference object among the plurality of objects included in the contents; and
identify an object selected through a UI corresponding to a selection of the preference object as the preference object.

9. The electronic apparatus as claimed in claim 1, wherein the instructions, executed by the one or more processors individually or collectively, cause the electronic apparatus to:
based on information corresponding to a first object included in an entire space corresponding to the contents and information corresponding to a second object included in each of the plurality of frames, obtain camera viewing angle information of each of the plurality of frames.

10. The electronic apparatus as claimed in claim 1, wherein the instructions, executed by the one or more processors individually or collectively, cause the electronic apparatus to:
based on an image, corresponding to contents displaying a position of the preference object with respect to each of the plurality of frames, being received from a server through a communication circuitry, obtain first position information of the preference object corresponding to the first frame; and
based on first position information of the preference object, control the display to output a user interface (UI) including an indicator corresponding to an estimated position of the preference object to the first frame.

11. A control method of an electronic apparatus, the control method comprising:
based on a plurality of frames corresponding to contents, obtaining a position corresponding to a preference object among a plurality of objects included in the contents of each of the plurality of frames through a first artificial intelligence model;
based on the preference object not being included in a first frame among the plurality of frames, obtaining position information of the preference object through a second artificial intelligence model, according to a position corresponding to the preference object with respect to each of the plurality of frames and camera viewing angle information of each of the plurality of frames; and
based on the position information of the preference object obtained through a second artificial intelligence model, outputting a user interface (UI) including an indicator corresponding to an estimated position of the preference object in the first frame.

12. The control method as claimed in claim 11, wherein the position information of the preference object is a first position information, and the control method comprises:
obtaining first viewing angle information of a camera corresponding to the first frame;
obtaining second position information of the preference object included in a second frame prior to the first frame, and second viewing angle information of a camera corresponding to the second frame;
obtaining third position information of the preference object included in a third frame between the first frame and the second frame, and third viewing angle information of a camera corresponding to the third frame; and
based on first viewing angle information of the camera, second position information of the preference object, second viewing angle information of the camera, third position information of the preference object, and third viewing angle information of the camera, obtaining the first position information of the preference object corresponding to the first frame through the second artificial intelligence model.

13. The control method as claimed in claim 11 comprising:
based on the preference object not being included in the first frame among the plurality of frames, inputting a position corresponding to the preference object with respect to each of the plurality of frames, camera viewing angle information of each of the plurality of frames and frame rate information of the plurality of frames to the second artificial intelligence model and obtaining first position information of the preference object corresponding to the first frame.

14. The control method as claimed in claim 11 comprising:
obtaining a top view image corresponding to an entire space of the contents; and
based on a plurality of object positions and the camera viewing angle information with respect to each of the plurality of frames, outputting the plurality of object positions and a visual field of a camera in a top view image corresponding to an entire space of the contents.

15. The control method as claimed in claim 14 comprising:
outputting a top view image of each of the plurality of frames, including the plurality of object positions and a visual field of the camera, to each of the plurality of frames in a picture-in-picture (PIP) form.

16. The control method as claimed in claim 11 comprising:
based on a plurality of object positions included in the first frame, outputting a UI associated with a position corresponding to the preference object to one of a plurality of edge areas of the first frame.

17. The control method as claimed in claim 11 comprising:
based on data corresponding to a plurality of captured images of the contents, obtained at a plurality of different capturing angles, obtaining a position corresponding to the preference object from the first frame according to data corresponding to the plurality of captured images.

18. The control method as claimed in claim 11 comprising:
outputting a UI corresponding to a selection of a preference object among the plurality of objects included in the contents; and
identifying an object selected through a UI corresponding to a selection of the preference object as the preference object.

19. The control method as claimed in claim 11 comprising:
based on information corresponding to a first object included in an entire space corresponding to the contents and information corresponding to a second object included in each of the plurality of frames, obtaining camera viewing angle information of each of the plurality of frames.

20. A non-transitory computer-readable storage medium storing computer instructions, executable by a processor of an electronic apparatus to cause the electronic apparatus to perform operations, the operations comprising:
based on a plurality of frames corresponding to contents, obtaining a position corresponding to a preference object among a plurality of objects included in the contents of each of the plurality of frames through a first artificial intelligence model;
based on the preference object not being included in a first frame among the plurality of frames, obtaining position information of the preference object through a second artificial intelligence model, according to a position corresponding to the preference object with respect to each of the plurality of frames and camera viewing angle information of each of the plurality of frames; and
based on the position information of the preference object obtained through the second artificial intelligence model, outputting a user interface (UI) including an indicator corresponding to an estimated position of the preference object in the first frame.
